(19) United States
(12) Patent Application Publication
(10) Pub. No.: US 2010/0289963 A1
(43) Pub. Date: Nov. 18, 2010

(54) Display Device for Aircraft Cockpit and Method for Managing a Video Data Network

(75) Inventors: Marc LeFort, Merignac (FR); Yves Sontag, Bordeaux (FR); Fabrice LaMargue, St Jean d'Illac (FR); Philippe Chabot, St Aubin de Medoc (FR)

Correspondence Address: BAKER & HOSTETLER LLP, WASHINGTON SQUARE, SUITE 1100, 1050 CONNECTICUT AVE. N.W., WASHINGTON, DC, 20036-5304, US

(73) Assignee: THALES, Neuilly Sur Seine (FR)

(21) Appl. No.: 12/682,637

(22) PCT Filed: Oct. 9, 2008
(86) PCT No.: PCT/EP2008/063563

§ 371 Date: Jun. 11, 2010

(30) Foreign Application Priority Data
Oct. 12, 2007 (FR) 0707181

(51) Int. Cl. H04N 5/268; H04N 9/67

(52) U.S. Cl. 348/659; 348/705; 348/E05.057; 348/E09.047

(57) ABSTRACT

The invention relates to a flat screen device (L2) comprising a multi-channel graphic generation (UGGL2) and a video data switch (50). It also relates to a method for managing a data network making it possible to improve the reliability of a network of several displays by improved management of all the graphic generations. The preferred field of application is that of display devices forming the cockpit of aircraft.

The field of the invention is that of display equipment for aircraft flight decks. The invention relates to the flat-screen displays forming the instrument panels of the cockpit and to the management of a data communication network between these various displays.

A display is a unit comprising two complementary functions. The first is the computing function CPU/GPU (Central Process Unit/Graphical Processor Unit) Graphic Generation Unit (UGG). This function generates an image on the basis of input parameters carried on an external data bus that can be of the AFDX (Avionics Full Duplex Ethernet), CAN (Controller Area Network) or A429 type for example and transmits a video data stream to the display. The second function is that of a displaying element. This function displays the image transmitted by the UGG function to the user. In the aviation field, the loss of a display does not affect flight safety because of the backed-up design of the system, with notably the possibility of reconfiguration of the display of the critical parameters on the displays that remain intact. Nevertheless, in most cases of failure, the crew requests the replacement of the defective display. In the case of an airline, this operation generates an additional operating cost because of the unavailability of the aircraft or because of the delay in the flight schedule. One way of reducing this type of cost is to increase the reliability of the equipment. Another way consists in producing a system architecture that is more robust in terms of availability. It is in this context that the invention is situated.

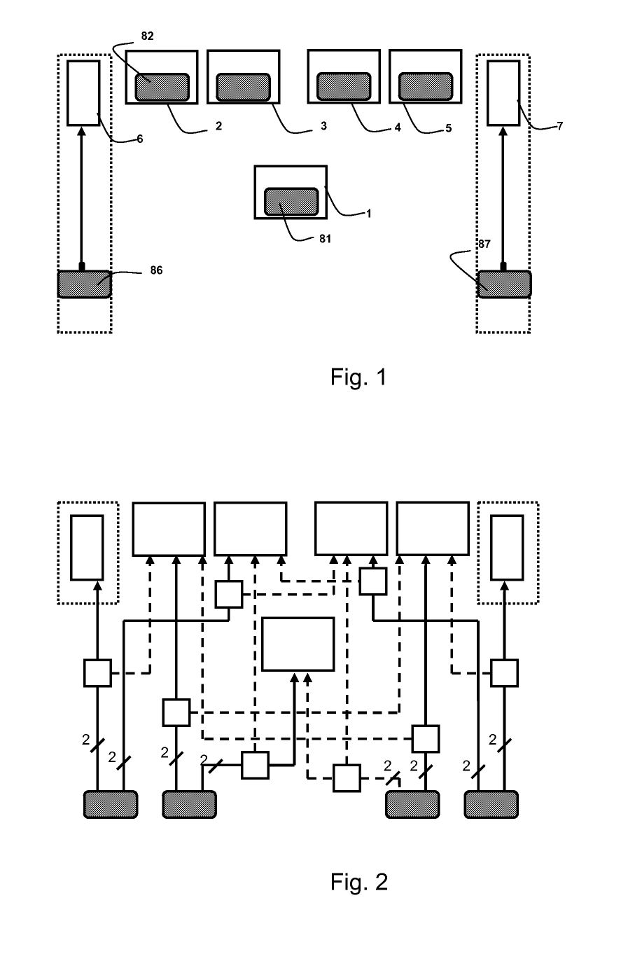

The current display networks can be divided into two types of architectures. The first is the SMART architecture in which the graphic computing function is incorporated into the display and has only one channel transmitting to a single screen. FIG. 1 shows an example of an architecture comprising five SMART Heads Down Displays (HDD) and two Heads Up Displays (HUD). The elements 1 to 5 are SMART displays, the elements 6 and 7 represent the optional HUDs with their external graphic generations 86 and 87. The elements 81 and 82 represent the single-channel graphic generations incorporated into the display 1 and 2. The main advantage of this architecture is that it minimizes the number of items of equipment, called Line Replaceable Units (LRUs) for example and minimizes the type of equipment. In the basic configuration, the only type of equipment is the display. The consequence of this is that it reduces the costs of managing the replacement hardware and makes it easier. This architecture also provides a saving in volume and in weight in the avionics compartment of the aircraft. The main drawback is the loss of the displaying equipment of the display when there is a failure of the associated UGG. This drawback involves a larger number of take-off delays because often the pilot requests the replacement of the affected display equipment. Another drawback appears when the architecture includes heads up displays (HUD). These items of equipment do not have graphic generation and the architecture therefore requires additional graphic generations in the video network to take responsibility for them.

The second architecture is the architecture called DUMB with multi-channel UGGs. This architecture consists of DUMB displays, that is to say with no integrated UGG, and of multi-channel graphic generations housed in an avionics compartment. FIG. 2 represents an example of an architecture consisting of five DUMB displays, four two-channel graphic generations and two optional HUDs. Each graphic generation has four video connections in order to connect the two video channels to several displays. The main advantage of this solution is transparency for the pilot of the failure of a graphic generation in the compartment. The presence of the UGGs and of the LRUs in the compartment makes it possible to have a communication network between these items of equipment and the displaying elements, and therefore to connect one displaying element to several displays. Specifically, when a UGG fails, the second channel of a second UGG takes over. Therefore, the pilot will not request the replacement of the display or of the UGG. Another advantage is the optimization of the number of UGGs, which is less important than in the previous SMART architecture and the possibility of being able to use certain items of DUMB equipment such as optional HUDs. The main drawback is that it maximizes the number of items of equipment such as the LRUs and the types of equipment. It is therefore necessary to have in reserve two types of replacement hardware: displays and UGGs. For the airplane, this architecture also involves certain disadvantages. The UGGs and the LRUs have to be placed in the avionics compartment and therefore require that an additional volume is reserved therein. The larger number of hardware items also has the effect of increasing the weight of the aircraft.

More precisely, the subject of the invention is a display device comprising a screen and electronic means for controlling the screen, characterized in that it comprises a graphic generation unit, comprising at least two channels, a BGG graphic data bus network, BGG graphic data bus inputs and outputs, a switch (50), and a means for detecting a failure and a means for controlling the switch; the switch directing, depending on the detected failures, the graphic data of the UGG and those originating from the BGG inputs either to the screen or to the BGG outputs. When a failure is detected, the display device has resources making it possible automatically to detect it and to put in place a new configuration of the BGG graphic data bus network in order to retrieve the failed function on another display. This new configuration has the advantage of using the additional UGG channels that are available by virtue of the switch allowing a flexible configuration of the BGG graphic data network. The BGG inputs and outputs are directed so that the BGG graphic data network works around a failure while all the same keeping a minimum safety level.

In a first embodiment, the device according to the invention forms the basic element of a network of display devices characterized in that it comprises at least two display devices according to the invention that are interconnected via their BGG inputs and outputs so that each display device is capable of transmitting an image, originating from its UGG or from external display devices, to any display device of the network by virtue of their respective switch. The cockpit of an aircraft consists of several networked displays. The display device according to the invention has hardware resources in order to put in place such a network without adding additional video network hardware.

In a second embodiment, the network of display devices comprises other display devices without UGG, the images of their screen then originating from a channel of the UGG of another display device of the network. The display device provides the network with the advantage of being able to connect heads up displays for example which do not have their own graphic generation.

In a third embodiment, the network of display devices comprises video sensors and the display devices comprise mixers used to modify the size and to mix together the images originating from the external video sensors and to mix them with the images originating from the UGGs.

In a fourth embodiment for an aircraft, the instrument panel comprises at least two display devices according to the invention connected in a network according to one of the above three embodiments.

Advantageously, the network of display devices is managed according to a method characterized in that the switch of the display devices is configured in at least four operating positions depending on the units that are operating or faulty:
In a first position, the UGG and the screen are operational, the switch being controlled by its UGG, the BGG graphic data are directed so as to connect a channel of the UGG to the screen, at least one channel of the UGG to the BGG outputs and the data originating from the BGG inputs to the BGG outputs.
In a second position, the UGG has failed and the screen is operational, the switch being controlled by a UGG of an external display device, the BGG graphic data are directed so as to connect the data originating from a first BGG input to the screen and the data originating from the other BGG inputs to the BGG outputs.
In a third position, the UGG is operational and the screen has failed, the switch being controlled by its UGG, the BGG graphic data are directed so as to connect a portion or all of the channels of the UGG to the BGG outputs and the data originating from the BGG inputs to the BGG outputs.
In a fourth position, the UGG and the screen have failed, the switch being controlled by a UGG of an external display device, the BGG data are directed so as to connect the data originating from the BGG inputs to the BGG outputs.

Advantageously, when the UGG of one or more displays of the network of display devices has failed, the network of display devices is managed according to a method characterized in that the network of BGG data bus switches is driven so that:
if a BGG input of the faulty display device is connected to a second display device one of the channels of which is available, the available channel of the UGG of this second display device generates the image of the faulty UGG and supplies it to the screen of the faulty display device.
if all the inputs of the faulty display device are connected to display devices, of which all the channels are used or of which the UGG is faulty, a display device of which one channel is available generates the image of the faulty display device and transmits it thereto via at least one display device being used as a relay.

The multi-channel graphic generation is capable of generating several images and of sending some of these images to other items of SMART display equipment or to items of DUMB equipment. This is of great value in the case of a failure of the graphic generation of a display. The fact that the display network has redundant graphic generation channels and is driven according to the method according to the invention for managing these resources thus means that the flight crew does not have to make use of a service operation for replacing the hardware at the time of the first failure while keeping a minimum of safety. In the case of an airline, said airline then prevents possible airplane delays due to the maintenance operation without the safety of the airplane being reduced thereby. This multi-channel display network therefore greatly increases the reliability of all the displays through better management of the resources present.

These multi-channel graphic generations also provide flexibility in the choices of configuration of the displays of the flight deck. It is possible to use the additional channels to provide a video feed to the items of equipment that do not have their own graphic generation. This architecture therefore makes it possible to respond easily to the specification upgrades requested by the aircraft manufacturer.

The invention incorporates the totality of the functions necessary to the construction of a network of displays for the instrument panel of an aircraft: the graphic generation, the displaying element, and the switch for the video signals. It therefore makes it possible to build a display network only by connecting these display devices together. This asset is a great advantage because it is not necessary to add other video equipment necessary to the construction of a network. This therefore prevents having to produce a new hardware architecture with each new cockpit specification. It is sufficient to connect the displays and configure the switches.

Moreover, the integration of the graphic generation and of the graphic data bus switch inside the display makes it possible to reduce, on the one hand, the number of types of different equipment to be incorporated into the aircraft and also the quantity of video cable, usually of fiber optic cable, connecting the displays of the network. In the architecture of FIG. 2, each section of cable carries only the video signal of a specific graphic generation. The invention makes it possible to share the various sections between each display and therefore to reduce their number. Optical fibers have a high cost. The invention therefore provides a substantial financial saving. Moreover, this architecture prevents the graphic generations being present inside the avionics compartment of the aircraft and provides additional space for other items of equipment. More generally, the displays incorporating the graphic generations and the switches reduce the number of secondary items of equipment such as the LRUs or the optical fibers and therefore make possible a saving in onboard weight in the aircraft.

The invention will be better understood and other advantages will appear on reading the following description given in a nonlimiting manner and thanks to the appended figures amongst which:

FIG. 1, according to the prior art, represents a display network architecture of the SMART type with single-channel graphic generations.

FIG. 2, according to the prior art, represents a display network architecture of the DUMB type with two-channel graphic generations.

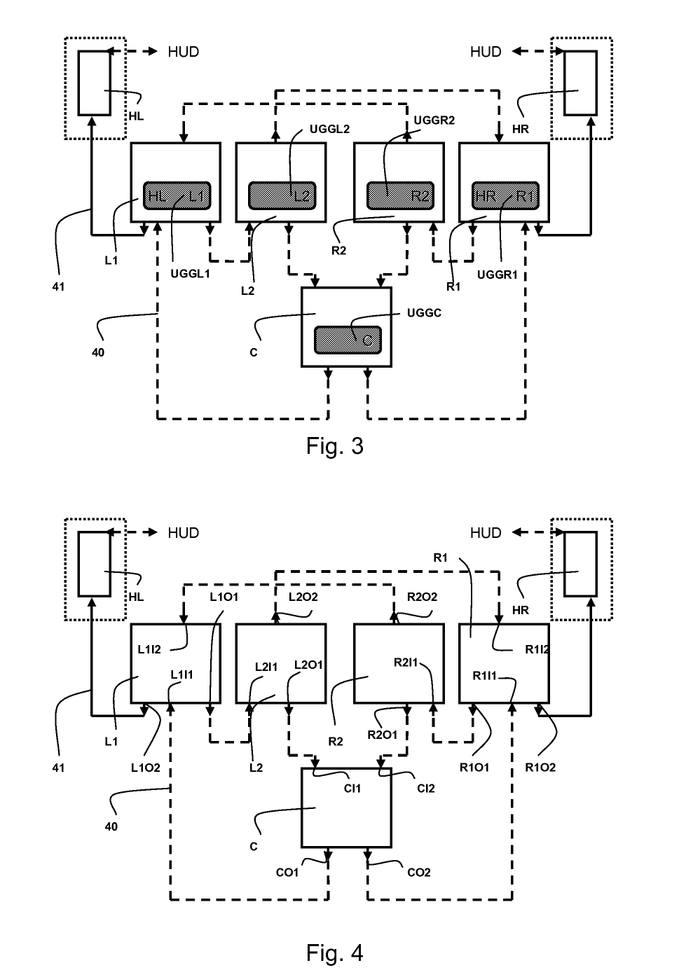

FIG. 3 represents a network of five displays according to the invention comprising two DUMB displays.

FIG. 4 represents the network as described in FIG. 3 with numbering of the inputs outputs of the video buses making it possible to correlate the network architecture with the various positions of the switch.

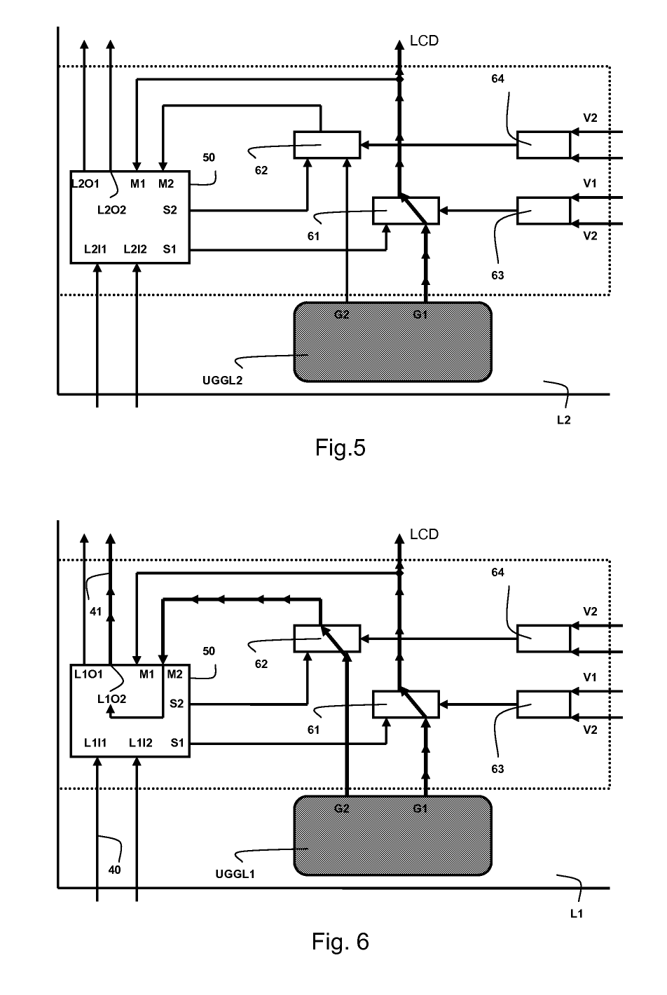

FIG. 5 represents the configuration of the video switches in nominal mode for the L2, R2 and C displays of the network as described in FIG. 3.

FIG. 6 represents the configuration of the video switches in nominal mode for the L1 and R1 displays of the network as described in FIG. 3.

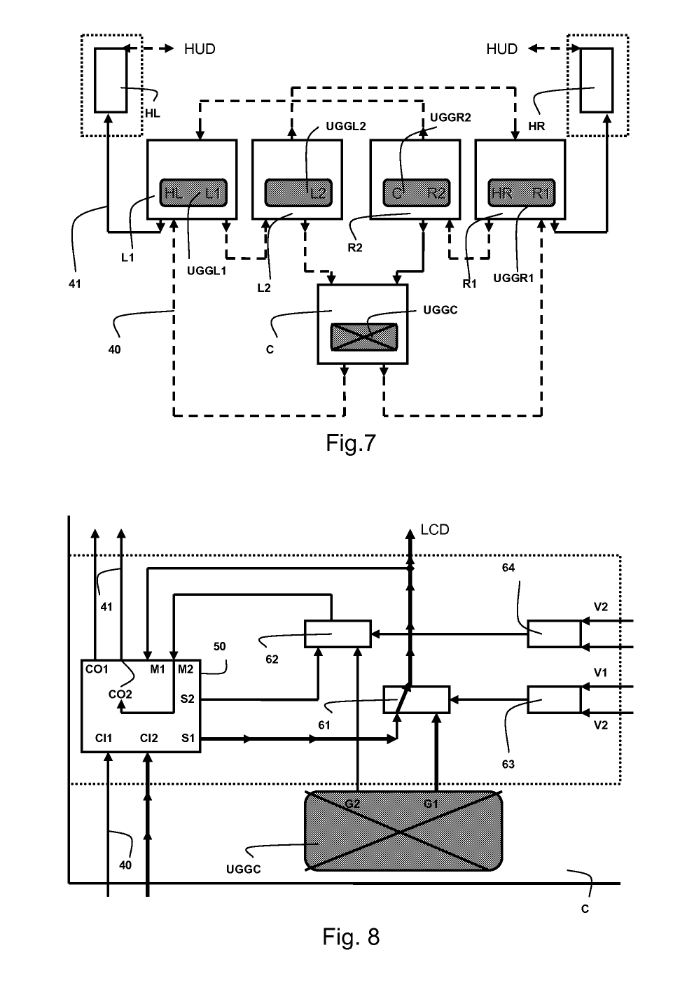

FIG. 7 represents a case in which the graphic generation of the C display fails in the network as described in FIG. 3.

FIG. 8 represents the configuration of the video switch for the C display in the network in the situation of FIG. 7.

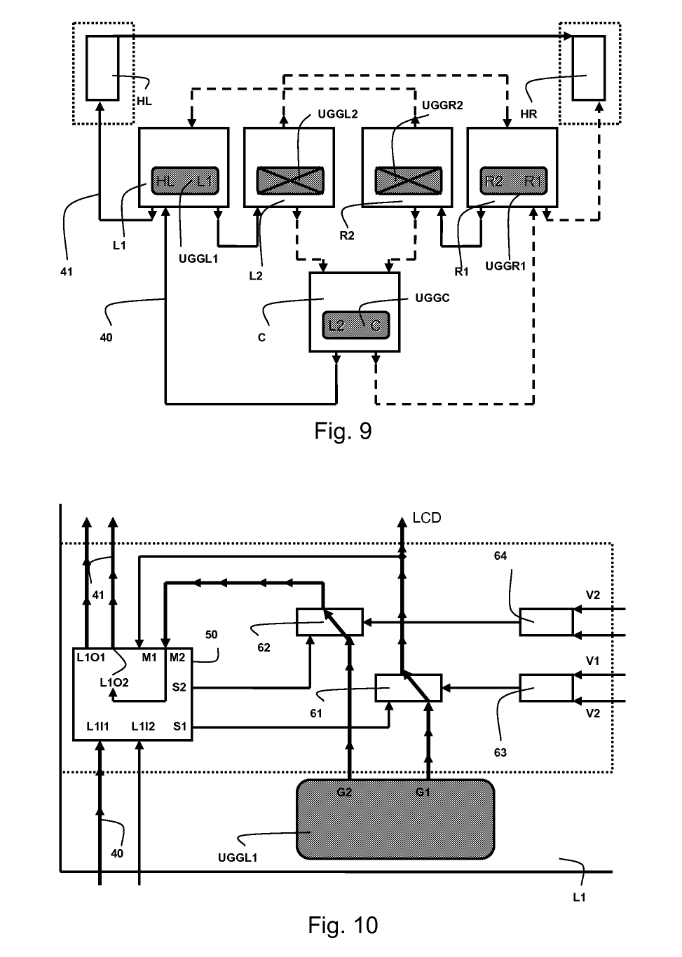

FIG. 9 represents a case in which the graphic generations of the L2 and R2 displays fail in the network as described in FIG. 3.

FIG. 10 represents the configuration of the video switch for the L1 display in the network in the situation of FIG. 9.

As a nonlimiting example, FIGS. 3 to 10 show the application on the flight deck of an aircraft and the operation of a network comprising five displays of the heads down display (HDD) type according to the invention and two DUMB displays used as heads up displays (HUD).

FIG. 3 represents the network of displays in nominal operation. The HDD displays are represented by the elements C, L1, L2, R1, R2. The two HUDs, HLs and HRs are respectively connected to L1 and L2. They are displays comprising no graphic generation, so their image is supplied by the L1 and L2 HDDs. Moreover, the two HUDs are interconnected thus making it possible to copy the image of one onto the screen of the other. The five HDDs, C, L1, L2, R1, R2, comprise two-channel graphic generations represented respectively by UGGC, UGGL1, UGGL2, UGGR1, UGGR2. Each display comprises two BGG inputs and two BGG outputs, for example L1I1, L1I2, L1O1 and L1O2 for the L1 display. The arrow 41 represents a video connection between a BGG output of L1 with a BGG input of HL. This connection is achieved by a fiber optic cable. In this figure, it is represented by a solid line arrow. This means that, in this operating mode, the video connection is active. The arrow 40 is a video connection linking CO1 of C to L1I1 of L1. The latter is represented in dashes meaning that the connection is not activated. The images that are to be displayed on the display screens are carried over the BGG video bus represented by the arrows. Each arrow represents a video connection of the fiber optic type and interconnects two displays. In this configuration, a display is capable of receiving two video inputs and of transmitting two video outputs. Each display, by virtue of the internal switch, is then capable of being used as a switch and a relay, and thus of transferring an image to any display.

FIG. 4 shows how the network is connected as a function of the two inputs and two outputs of each display. For the purposes of clarity, the UGGs are not shown.

This network is organized so that:
The BGG outputs of L1 are connected to a BGG input of HL and L2.
The BGG outputs of L2 are connected to a BGG input of R1 and C.
The BGG outputs of R2 are connected to a BGG input of L1 and C.
The BGG outputs of R1 are connected to a BGG input of HR and R2.
The BGG outputs of C are connected to a BGG input of L1 and R1.

FIG. 5 represents the configuration of the switch of the L2 display in nominal operation. The displays also comprise inputs for the external video sources, V1 and V2, and mixers 61, 62, 63 and 64 making it possible to mix the videos V1 and V2 together and with the images of the graphic generations. The first channel of the UGG is connected to the display screen. The video stream is represented by the thicker arrow comprising several arrow points. No video stream passes through the BGG inputs and outputs. This configuration corresponds to that of the C, L2 and R2 displays in a nominal operation.

FIG. 6 represents the configuration of the switch of the L1 display in nominal operation. The first channel supplies the images to the screen and the second channel is used to power the HL display. In this configuration, a mixer 61 makes it possible to mix images originating from external videos from a mixer 63 with that originating from channel 1 of the UGG, and also makes it possible to change their size. A mixer 62 makes it possible to mix the images originating from external videos from a mixer 64 with that originating from channel 2 of the UGG. The output of the mixer 62 is connected to the input M2 of the switch, controlled by UGGL1, which directs this input to the BGG output L1O2. This BGG output L1O2 is connected to the HL display. In nominal operation, the L1 and R1 displays are configured in this manner. This figure illustrates the advantage of the architecture making it possible to use optional equipment such as HUDs without having to add video sources that have to be placed in the avionics compartment.

FIG. 7 represents the case in which the C HDD fails and is therefore no longer capable of supplying the image of its own display. A BGG input of C is connected to R2 the graphic generation of which has an unused channel. UGGR2 then generates the image of the display C and likewise controls the switch of C so that it directs the corresponding video input to its screen. The R2 display is then configured in the same way as the L1 and R1 displays except that the R2O1 output takes the place of the L1O2 output.

FIG. 8 represents the configuration of the switch of the C display when the latter has failed. If the switch detects no control signal originating from UGGC, it detects that UGGC has failed. UGGC is no longer capable of controlling the switch 50 which is then driven by UGGR2 of the R2 display via the CI2 of the switch 50. The switch is driven so that the CI2 input is directed to the S1 output of the switch thus transmitting the image originating from the R2 display to the mixer 61 and finally to the screen. This figure shows the ability of the architecture to manage these available resources in order to adapt to a graphic generation failure. This therefore makes it possible to prevent a maintenance operation while maintaining minimal safety.

FIG. 9 represents the case in which the L2 and R2 displays fail. The image of R2 is then created by UGGR1 which then no longer generates the image of the HR HUD. In this architecture with five two-channel displays, there are resources for ten screens. If two UGGs fail, there are then resources for only six screens. This configuration has seven screens. The network is managed so that the HL HUD then copies its image to the screen of the HR HUD. The image of L2 is generated by the C display which supplies the image to L2 by using the switch of L1 as a relay. This figure shows the advantage of the invention in the case of multiple failures. Each display is capable of being used as a video relay and therefore of bringing an image to any display in the network. If necessary, in a network comprising more displays, it is possible to imagine a video stream relay between more than two displays. The invention therefore makes it possible to greatly improve the reliability of a network within the limits of the available resources.

FIG. 10 represents the configuration of the switch of the L1 display and how the relay and dual-source video function is managed. The first channel of the UGG transfers to the screen via the mixer 61, the second channel is transmitted to the HL HUD by virtue of the switch which directs the channel to the L1O2 BGG output and finally the input L1I1, at which the graphic signal of C arrives, is directed to the L1O1 output which is connected to L2 the UGG of which has failed.

The invention is not limited to a network as described in FIGS. 3 to 10. The advantage of this type of display stems from the fact that the functionalities of routing and redundant resources are incorporated into the equipment. It is therefore possible to construct a network with a variable number of displays providing improved reliability through the connection of several multi-channel displays according to the invention. The graphic generations may have two or more channels and consequently the display may have two or more inputs outputs.

1. A network of a plurality of display devices (HL, HR, L1, L2, R1, R2, C) comprising a graphic generation unit UGG comprising at least two channels, a screen, electronic means for controlling the screen and graphic data bus inputs and outputs BGG, characterized in that each display device comprises:
a network of graphic data,
a switch (50),
a means for detecting a failure and a means for controlling the switch;
the switch directing to the graphic data network, according to the detected failures, the graphic data of the UGG and those originating from the BGG inputs either to the screen or to the BGG outputs, and in that the network of display devices allows a first display device (L1) to be used as a relay and to transmit an image originating from a second display device (C) to a third display device (L2) of the network (FIG. 9).

2. The network as claimed in claim 1, characterized in that the network is assembled so that each of the graphic data inputs and outputs (L1I1) of a first display device (L1) is connected to a second display device (C) distinct from those (HL, L2, R2) connected to the other graphic data inputs and outputs (L1I2, L1O1, L1O2) of the first display device (FIGS. 3 to 10).

3. The network as claimed in claim 2, characterized in that it comprises display devices without UGG (HL, HR), the images of their screen then being generated via a channel of the UGG from a display device of the network (L1, R1).

4. The network as claimed in claim 3, characterized in that it comprises video sensors and in that the display devices (C, L1, L2, R1, R2) comprise mixers (61-64) that are used to modify the size and to mix together the images originating from the external video sensors and to mix them with the images originating from the UGGs.

5. The network as claimed in claim 3, characterized in that it forms the display means of an aircraft instrument panel.

6. A method for managing a network of display devices as claimed in one of claims 2 to 5, characterized in that the switch of the display devices is configured in at least four operating positions depending on the units that are operating or faulty:
In a first position, the UGG and the screen are operational, the switch being controlled by its UGG, the BGG graphic data are directed so as to connect a channel of the UGG to the screen, at least one channel of the UGG to the BGG outputs and the data originating from the BGG inputs to the BGG outputs.
In a second position, the UGG has failed and the screen is operational, the switch being controlled by a UGG of an external display device, the BGG graphic data are directed so as to connect the data originating from a first BGG input to the screen and the data originating from the other BGG inputs to the BGG outputs.
In a third position, the UGG is operational and the screen has failed, the switch being controlled by its UGG, the BGG graphic data are directed so as to connect a portion or all of the channels of the UGG to the BGG outputs and the data originating from the BGG inputs to the BGG outputs.
In a fourth position, the UGG and the screen have failed, the switch being controlled by a UGG of an external display device, the BGG data are directed so as to connect the data originating from the BGG inputs to the BGG outputs.

7. The method for managing a network of display devices as claimed in claim 6, characterized in that, when the UGG of one or more display devices of the network is faulty, the network of the BGG data bus switches is driven so that:
if a BGG input of the faulty display device is connected to a second display device one of the channels of which is available, the available channel of the UGG of this second display device generates the image of the faulty UGG and supplies it to the screen of the faulty display device.
if all the inputs of the faulty display device are connected to display devices, of which all the channels are used or of which the UGG is faulty, a display device of which one channel is available generates the image of the faulty display device and transmits it thereto via at least one display device being used as a relay.
